(19) United States
(12) Patent Application Publication
(10) Pub. No.: US 2013/0027286 A1
(43) Pub. Date: Jan. 31, 2013

(54) LCD PANEL

(71) Applicant: Xiu-feng Zhou, Shenzhen (CN)

(72) Inventor: Xiu-feng Zhou, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/378,037

(22) PCT Filed: Aug. 31, 2011
(86) PCT No.: PCT/CN2011/079195

§ 371 Date: Dec. 13, 2011

(30) Foreign Application Priority Data
Jul. 28, 2011 (CN) 201120270715.0

(51) Int. Cl. G09G 3/36

(52) U.S. Cl. 345/92

(57) ABSTRACT

The present invention discloses an LCD panel which includes a plurality of data lines and a plurality of scan lines, the data lines insulatingly intersecting the gate lines, thereby defining a pixel unit between an intersection between two of the plurality of gate lines and corresponding two of the plurality of data lines. Three adjacent scan lines intersect three adjacent data lines to define four pixel units which are designated as a pixel unit set. Two pixel units in one row of the pixel unit set are respectively coupled to two data lines in both sides of the three adjacent data lines, and two pixel units in the other row are coupled to the middle one of the three adjacent data lines. Power consumption of the LCD panel of the present invention is greatly reduced as compared with the conventional LCD panel.

### FIELD OF THE INVENTION

The present invention relates to a liquid crystal display (LCD), and especially to an LCD panel.

### BACKGROUND OF THE INVENTION

With a growing popularity of LCDs, LCDs are demanded for better functions.

Referring to FIG. 1, FIG. 1 is a schematic drawing illustrating pixel structures of an LCD panel in the prior art. The LCD panel includes m data lines D″1˜D″m and n scan lines G″1˜G″n. The data lines intersect the scan lines, and two adjacent data lines intersect two adjacent scan lines to define a pixel unit (not labeled). A thin film transistor (TFT) and a liquid crystal capacitor (not shown) are disposed in each pixel unit.

Data signals that are transmitted on the data lines D″1˜D″m can be divided into data signals with a positive polarity and data signals with a negative polarity reference to a common voltage Vcom which is 0 v. The data signals with the positive polarity means that the voltages of data signals are higher than the common voltage Vcom, and the data signals with the negative polarity means that the voltages of data signals are lower than the common voltage Vcom. When a data signal with the positive polarity and a data signal with the negative polarity both have the same gray scale value, theoretically, they have the same display effects.

Liquid crystal molecules have followed common character: when both sides of a liquid crystal layer are applied to electric field and if the direction of the electric field is kept constant for a long time, the character of the liquid crystal molecules is destroyed. That is, the liquid crystal molecules fail to rotate in response to changes of the electric field for forming various gray scales. Therefore, the direction of the electric field has to change every a period of time for reversing the liquid crystal molecules, thereby preventing the characteristics of the liquid crystal molecules from being destroyed. Therefore, there are a variety of driving methods to realize the reversal of the liquid crystal molecules in the LCD field, such as dot inversion, frame inversion, column inversion, and row inversion.

When the driving method of the row inversion is employed in the above-mentioned LCD panel as shown in FIG. 1, the direction of the electric field of the liquid crystal capacitances in an odd row of the pixel units is opposite to the direction of the electric field of the liquid crystal capacitances in an even row of the pixel units. Thus, the voltages of an odd column of data lines D″2k−1 and the voltages of an even column of data lines D″2k have to continuously switch their polarity in a frame time T as shown in FIG. 2. However, the frequent polarity switching must increase power consumption of the LCD panel, thereby resulting in waste of resources.

### SUMMARY OF THE INVENTION

An objective of the present invention is to provide an LCD panel to overcome the drawback that the frequent polarity switching on the data lines must increase the power consumption of the LCD panel driven by using the row inversion in the prior art and the waste of the resources.

To achieve the foregoing objective, according to an aspect of the present invention, an LCD panel includes a plurality of data lines and a plurality of scan lines, the data lines insulatingly intersecting the gate lines, thereby defining a pixel unit between two gate lines and corresponding data lines.

three adjacent scan lines intersecting three adjacent data lines define four pixel units which are designated as a pixel unit set, and two pixel units in upper row of the pixel unit set are respectively coupled to two data lines in both sides of the three adjacent data lines, and two pixel units in the lower row of the pixel unit set are coupled to the middle one of the three adjacent data lines; wherein there is a thin film transistor (TFT) disposed on each pixel unit, and the source electrodes of TFTs in the two pixel units of the upper row of the pixel unit set are respectively coupled to the two data lines in both sides of three adjacent data lines, and the source electrodes of TFTs in the two pixel units of the lower row are coupled to the middle one of three adjacent data lines.

In one embodiment of the present invention, the two adjacent pixel units in a same row are respectively coupled to two adjacent scan lines in both sides of the same row.

In one embodiment of the present invention, a plurality of pixel unit sets is sequentially arranged in the row direction which is parallel to the scan lines.

In one embodiment of the present invention, a plurality of pixel unit sets is sequentially arranged in the column direction which is parallel to the data lines.

In one embodiment of the present invention, the gate electrodes of the TFTs disposed on the two adjacent pixel units in the same row are respectively coupled to two adjacent scan lines at both sides of the same row.

Another objective of the present invention is to provide an LCD panel to overcome the drawback that the frequent polarity switching must increase the power consumption of the LCD panel and the waste of the resources in the prior art.

To achieve the foregoing objective, according to another aspect of the present invention, an LCD panel includes a plurality of data lines and a plurality of scan lines, in which the data lines insulatingly intersecting the gate lines, thereby defining a pixel unit between two gate lines and corresponding data lines. Three adjacent scan lines intersecting three adjacent data lines define four pixel units which are designated as a pixel unit set. Two pixel units in one row of the pixel unit set are respectively coupled to two data lines at both sides of the three adjacent data lines, and two pixel units in the other row are coupled to the middle one of the three adjacent data lines.

In one embodiment of the present invention, the two adjacent pixel units in a same row are respectively coupled to two adjacent scan lines at the same row.

In one embodiment of the present invention, the two pixel units in an upper row of the pixel unit set are respectively coupled to the two data lines in the both sides of the three adjacent data lines, and two pixel units of a lower row are coupled to the middle one of the three adjacent data lines.

In one embodiment of the present invention, a plurality of pixel unit sets is sequentially arranged in the row direction which is parallel to the scan lines.

In one embodiment of the present invention, a plurality of pixel unit sets is sequentially arranged in the column direction which is parallel to the data lines.

In one embodiment of the present invention, there is a thin film transistor (TFT) disposed in each pixel unit, and source electrodes of TFTs in the two pixel units of the row of the pixel unit set are respectively coupled to the two data lines in both sides of three adjacent data lines, and source electrodes of TFTs in the two pixel units of the other row are coupled to the middle one of three adjacent data lines.

In one embodiment of the present invention, the gate electrodes of the TFTs disposed on the two adjacent pixel units in the same row are respectively coupled to two adjacent scan lines in both sides of the same row.

Compared with the prior art, the gray scale voltages with two opposite polarities can be respectively written into the pixel units in the odd row and the pixel units in the even row respectively via an odd number column of the data lines and an even column of the data lines for realizing the row inversion without continuously switching the polarities of the data lines. Therefore, the power consumption of the LCD panel of the present invention is greatly reduced.

It is to be understood that both the foregoing general description and the following detailed description of the present invention are exemplary and explanatory and are intended to provide further explanation of the invention as claimed:

### DESCRIPTION OF THE DRAWINGS

FIG. 1 is a schematic drawing illustrating pixel structures of an LCD panel in the prior art;

FIG. 2 is a schematic drawing illustrating waveforms of the data lines of the LCD panel driven by using the row inversion in FIG. 1;

FIG. 3 is a schematic drawing illustrating an LCD panel according to one preferred embodiment of the present invention;

FIG. 4 is a schematic drawing illustrating a pixel unit set of the LCD panel shown in FIG. 3; and

FIG. 5 is a schematic drawing illustrating waveforms of the data lines of the LCD panel driven by using the row inversion in FIG. 3.

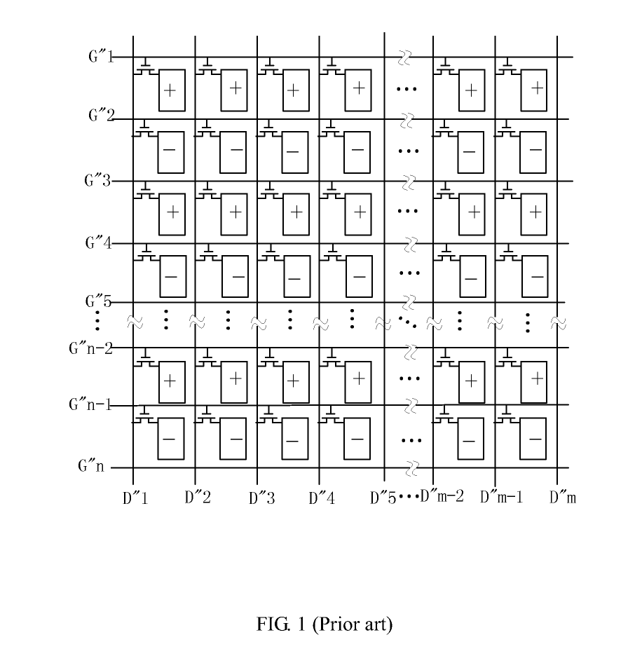

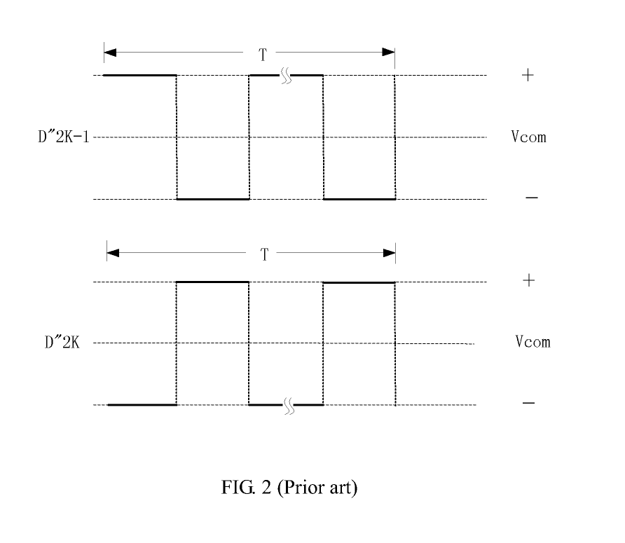

### DETAILED DESCRIPTION OF THE PREFERRED EMBODIMENTS

Descriptions of the following embodiments refer to attached drawings which are utilized to exemplify specific embodiments.

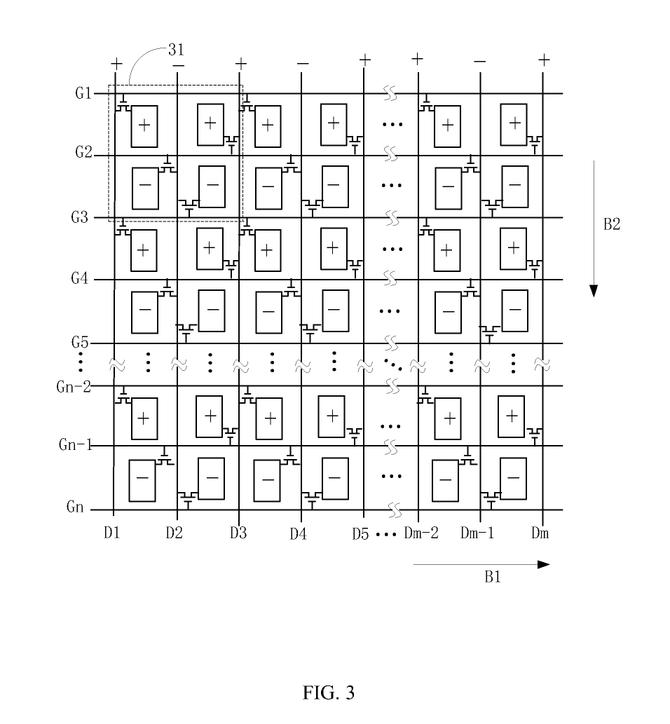

FIG. 3 is a schematic drawing illustrating an LCD panel according to one preferred embodiment of the present invention.

The LCD panel includes a plurality of pixels, m data lines D1˜Dm, and n scan lines G1˜Gn, the data lines intersect the scan lines. It is easily known that two adjacent data lines intersect two adjacent scan lines to define a pixel unit (not labeled). There is a thin film transistor (TFT) and a liquid crystal capacitor (not shown) disposed on each pixel unit. The scan lines are utilized to provide scanning signals for the pixel units. The data lines are utilized to provide gray scale voltages for the pixel units.

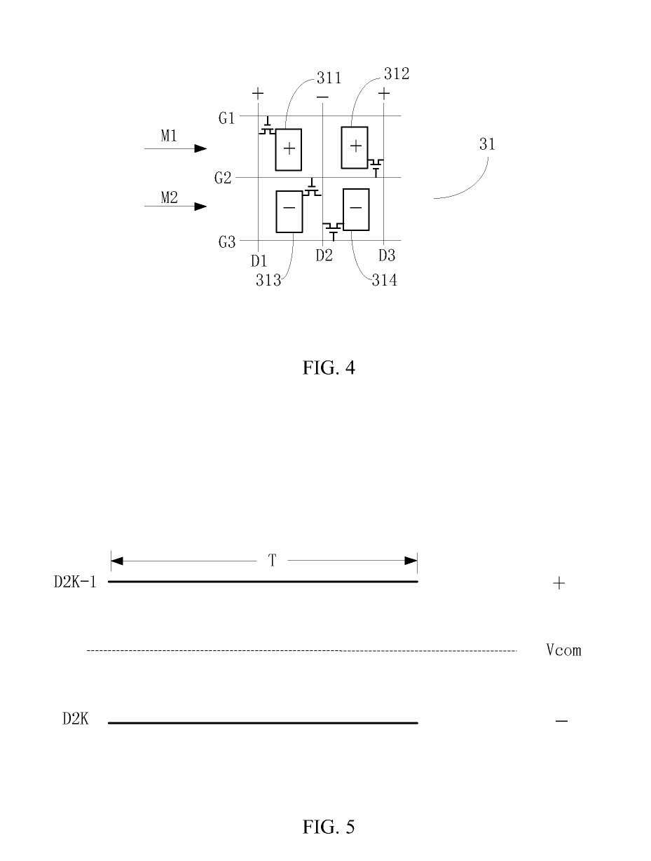

Referring to FIG. 3 and FIG. 4, three adjacent scan lines G1, G2, and G3 intersect three adjacent data lines D1, D2, and D3 to define four pixel units 311, 312, 313, and 314 which are designated as a pixel unit set 31. A plurality of the pixel unit sets is sequentially arranged in the row direction B1 which is parallel to the scan lines, and at the same time a plurality of the pixel unit sets is sequentially arranged in the column direction B2 which is parallel to the data lines.

In the pixel unit set 31, source electrodes of the TFTs of the two pixel units 311 and 312 of an upper row (i.e., M1 row) are respectively coupled to the data lines D1 and D2, and source electrodes of two TFTs in the two pixel units 313 and 314 of a lower row (i.e., M2 row) are coupled to the data line D2 in the middle of the three adjacent data lines D1, D2, D3. The two pixel units at a same row are provided scanning signals by two adjacent scan lines which are adjacent at the same row. Specifically, gate electrodes of TFTs in the two adjacent pixel units 311 and 312 at M1 row are respectively coupled to the two adjacent scan lines G1 and G2, and two gate electrodes of two TFTs of the two adjacent pixel units 313 and 314 at M2 row are respectively coupled to the two adjacent scan lines G2 and G3.

In other embodiment, configurations of the pixel units at the upper row and the lower row can be exchanged.

Referring to FIG. 5, FIG. 5 is a schematic drawing illustrating waveforms of the data lines of the LCD panel driven by using the row inversion in FIG. 3. The polarity of the gray scale voltage of each data line remains unchanged for a frame time T, and the two adjacent data lines D2k−1 and D2k are provided the gray scale voltages with two opposite polarities. In the embodiment, the gray scale voltages of the data lines D2k−1 disposed on an odd column is a positive polarity (i.e., the voltage is more than the common voltage Vcom), and the gray scale voltages of the data lines D2k disposed on an even column is a negative polarity (i.e., the voltage is less than the common voltage Vcom), where K is an arbitrary natural number.

Referring to FIG. 4 and FIG. 5 again, a display method of the pixel unit set 31 of the LCD panel is described as follows.

Firstly, the scan line G1 provides a scanning signal, and the TFT of the pixel unit 311 is turned on; meanwhile, the data line D1 provides a gray scale voltage with a positive polarity to the pixel unit 311.

Then, the scan line G2 provides a scanning signal, and the TFTs of the pixel units 312 and 313 are turned on simultaneously; meanwhile, the data line D2 provides a gray scale voltage with a negative polarity to the pixel unit 313, and the data line D3 provides a gray scale voltage with a positive polarity to the pixel unit 312.

Finally, the scan line G3 provides a scanning signal, and the TFT of the pixel unit 314 is turned on; meanwhile, the data line D2 provides a gray scale voltage with a negative polarity to the pixel unit 314.

As mentioned above, the gray scale voltages with the positive polarity of the data lines D1 and D3 are provided to the pixel units of the first row, and the gray scale voltage with the positive polarity of the data line D2 is provided to the pixel units of the second row. A display method of other pixel unit sets 31 are the same to the display method of said pixel unit set 31. Therefore, the gray scale voltages with the positive polarity of the odd column of the data lines D2k−1 are written into the odd row of the pixel units, and the gray scale voltages with the negative polarity of the even column of the data lines D2k are written into the even row of the pixel units, so that the polarities of the gray scale voltages written into each row of the pixel units of the LCD panel are opposite so as to realize the inversion driving.

Compared with the prior art, the gray scale voltages with two opposite polarities can be respectively written into the odd row of the pixel units and the even row of the pixel units respectively via an odd number column of the data lines D2k−1 and an even column of the data lines D2k for realizing the row inversion without continuously switching the polarities of the data lines. Thus, the power consumption of the LCD panel of the present invention is greatly reduced as compared with the conventional LCD panel.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An LCD panel, comprising a plurality of data lines and a plurality of scan lines insulatingly intersecting the data lines, a pixel unit defined by two gate lines and corresponding data lines; characterized in that: three adjacent scan lines intersecting three adjacent data lines define four pixel units which are designated as a pixel unit set, and two pixel units in upper row of the pixel unit set are respectively coupled to two data lines in both sides of the three adjacent data lines, and two pixel units in the lower row of the pixel unit set are coupled to the middle one of the three adjacent data lines; wherein there is a thin film transistor (TFT) disposed on each pixel unit, and the source electrodes of TFTs in the two pixel units of the upper row of the pixel unit set are respectively coupled to the two data lines in both sides of three adjacent data lines, and the source electrodes of TFTs in the two pixel units of the lower row are coupled to the middle one of three adjacent data lines.

2. The LCD panel according to claim 1, characterized in that the two adjacent pixel units in a same row are respectively coupled to two adjacent scan lines in both sides of the same row.

3. The LCD panel according to claim 2, characterized in that a plurality of pixel unit sets is sequentially arranged in the row direction which is parallel to the scan lines.

4. The LCD panel according to claim 3, characterized in that a plurality of pixel unit sets is sequentially arranged in the column direction which is parallel to the data lines.

5. The LCD panel according to claim 2, characterized in that the gate electrodes of the TFTs disposed on the two adjacent pixel units in the same row are respectively coupled to corresponding scan lines in both sides of the same row.

6. An LCD panel, comprising a plurality of data lines and a plurality of scan lines, the data lines insulatingly intersecting the gate lines, a pixel unit defined by two gate lines and corresponding data lines, characterized in that:
three adjacent scan lines intersecting three adjacent data lines define four pixel units which are designated as a pixel unit set, and two pixel units in one row of the pixel unit set are respectively coupled to two data lines in both sides of the three adjacent data lines, and two pixel units of the other row are coupled to the middle one of the three adjacent data lines.

7. The LCD panel according to claim 6, characterized in that the two adjacent pixel units in a same row are respectively coupled to two adjacent scan lines at the same row.

8. The LCD panel according to claim 7, characterized in that the two pixel units in the upper row of the pixel unit set are respectively coupled to the two data lines in the both sides of the three adjacent data lines, and two pixel units of the lower row are coupled to the middle one of the three adjacent data lines.

9. The LCD panel according to claim 8, characterized in that a plurality of pixel unit sets is sequentially arranged in the row direction which is parallel to the scan lines.

10. The LCD panel according to claim 9, characterized in that a plurality of pixel unit sets is sequentially arranged in the column direction which is parallel to the data lines.

11. The LCD panel according to claim 7, characterized in that there is a thin film transistor (TFT) disposed into each pixel unit, and source electrodes of TFTs in the two pixel units of one row of the pixel unit set are respectively coupled to the two data lines in both sides of three adjacent data lines, and source electrodes of TFTs in the two pixel units of the other row thereof are coupled to the middle one of three adjacent data lines.

12. The LCD panel according to claim 11, characterized in that the gate electrodes of the TFTs disposed on the two adjacent pixel units in the same row are respectively coupled to two adjacent scan lines at both sides of the same row.
